(19) United States
(12) Patent Application Publication
(10) Pub. No.: US 2022/0196868 A1
(43) Pub. Date: Jun. 23, 2022

(54) UNPOWERED NODE TRANSFER DEVICE FOR MARINE SEISMIC OPERATIONS

(71) Applicant: Magseis FF LLC, Houston, TX (US)

(72) Inventors: Chance MANN, Magnolia, TX (US); Roger L. FYFFE, Sugar Land, TX (US)

(21) Appl. No.: 17/125,549

(22) Filed: Dec. 17, 2020

(51) Int. Cl. G01V 1/38; B63G 8/00; B63B 21/66

(52) U.S. Cl. CPC G01V 1/3852; B63B 21/66; B63G 8/001

(57) ABSTRACT

Performing a seismic survey in an aqueous medium is provided. A system can include a transfer device with a first vertical side and a second vertical side. The transfer device can include a chute to receive units. The chute extends from the first vertical side to the second vertical side. The chute has a first end at the first vertical side that is higher than a second end at the second vertical side opposite the first end to establish a first slope for the chute, which causes the units to slide from the first end towards the second end via gravity. The transfer device includes a retainer at the second end of the chute to be actuated by an arm of a first underwater vehicle that mates with the chute. The transfer device can be towed by a marine vessel via an unpowered rope.

### BACKGROUND

Seismic surveys can be performed to identify subsurface lithological formations or hydrocarbons. The seismic surveys can be performed on land or in an aqueous medium, such as in the ocean or sea.

### SUMMARY

At least one aspect is directed to a system to perform a seismic survey in an aqueous medium. The system can include a transfer device. The transfer device can include a first vertical side and a second vertical side opposite the first vertical side. The transfer device can include a first chute. The first chute can extend from the first vertical side to the second vertical side and traverse a vertical axis of the transfer device. The first chute can have a first end at the first vertical side that is higher than a second end at the second vertical side opposite the first end to establish a first slope for the first chute. The first chute can receive a first plurality of units, and the first slope of the first chute can cause the first plurality of units to slide from the first end of the first chute towards the second end of the first chute via gravity. The transfer device can include a retainer at the second end of the first chute. The retainer can be actuated by an arm of a first underwater vehicle that mates with the first chute. The transfer device can include a rope connector affixed to a portion of the transfer device. The rope connector can couple a first end of a rope to the transfer device. A second end of the rope can couple to a component on a marine vessel to tow the transfer device through the aqueous medium.

In some implementations, the transfer device can include a second chute that receives a second plurality of units. The second chute can have a third end at the first vertical side and a fourth end at the second vertical side, wherein the third end is higher than the fourth end. The second chute can have a second slope that matches the first slope of the first chute.

The transfer device can include one or more skegs to provide directional stabilization for the transfer device towed by the marine vessel in the aqueous medium. The transfer device can receive, at the first end of the first chute, a first seismic data acquisition of the first plurality of units from the first underwater vehicle or a conveyor on the marine vessel. The transfer device can present, at the second end of the first chute, a first unit of the first plurality of units to the first underwater vehicle for deployment on a seabed.

The transfer device can include a second chute to receive a second plurality of units, the second chute having a third end at the first vertical side and a fourth end at the second vertical side, wherein the third end is lower than the fourth end. The second chute can have a second slope that is opposite of the first slope of the first chute. The transfer device can receive, at the first end of the first chute, at least one of the first plurality of units from the first underwater vehicle. The transfer device can receive, at the fourth end of the second chute, at least one of the second plurality of units from a second underwater vehicle. Receipt of the first plurality of units by the first chute can overlap with receipt of the second plurality of units by the second chute.

The transfer device can be unpowered and the rope lacks a power delivery capability.

The transfer device can include four first chutes having the first slope. The four second chutes can have a second slope opposite the first slope, wherein each of the four first chutes and each of the four second chutes is configured to hold at least twenty units. The first chute can include a damper configured to dampen a rate at which the first plurality of units slide down the first chute from the first end to the second end. The first plurality of units can include a plurality of seismic units to collect seismic data corresponding to signals reflected or refracted off subsurface features.

At least one aspect is directed to a method to perform a seismic survey in an aqueous medium. The method can include providing a transfer device. The transfer device can include a first vertical side and a second vertical side opposite the first vertical side. The transfer device can include a first chute extending from the first vertical side to the second vertical side and traversing a vertical axis of the transfer device. The first chute can have a first end at the first vertical side that is higher than a second end at the second vertical side opposite the first end to establish a first slope for the first chute. The transfer device can include a retainer at the second end of the first chute. The transfer device can include a rope connector affixed to a portion of the transfer device. The method can include mating a first underwater vehicle at the first end of the first chute. The method can include receiving, by the first chute at the first end, a first plurality of units from the first underwater vehicle. The method can include sliding, by the first plurality of units, from the first end of the first chute towards the second end of the first chute via gravity.

In some implementations, the method can include receiving, by a second chute, a second plurality of units. The second chute can have a third end at the first vertical side and a fourth end at the second vertical side. The third end can be higher than the fourth end. The second chute can have a second slope that matches the first slope of the first chute.

The method can include receiving, by a second chute of the transfer device, a second plurality of units. The second chute can have a third end at the first vertical side and a fourth end at the second vertical side. The third end can be lower than the fourth end. The second chute can have a second slope that is opposite of the first slope of the first chute. The method can include receiving, by the transfer device at the first end of the first chute, at least one of the first plurality of units from the first underwater vehicle. The method can include receiving, by the transfer device at the fourth end of the second chute, at least one of the second plurality of units from a second underwater vehicle.

The first underwater vehicle can mate with the first vertical side of the transfer device at a same time as the second underwater vehicle is mated with the second vertical side of the transfer device. The method can include retrieving, by the first underwater vehicle, a first unit of the first plurality of units from the second end of the first chute. The method can include placing, by the first underwater vehicle, the first unit in contact with a seabed.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 depicts an isometric schematic view of an example of a seismic operation in deep water, in accordance with an implementation.

FIG. 2 depicts an illustration of a side view of a transfer device with multiple chutes to perform a seismic survey in an aqueous medium, in accordance with an implementation.

FIG. 3 depicts an illustration of a top view of a transfer device with multiple chutes to perform a seismic survey in an aqueous medium, in accordance with an implementation.

FIG. 4 depicts a flow diagram of a method of performing a seismic survey in an aqueous medium, in accordance with an implementation.

FIG. 5 depicts a block diagram of an architecture for a computing system employed to implement various elements of the system depicted in FIG. 1 or the method depicted in FIG. 2.

Like reference numbers and designations in the various drawings indicate like elements.

### DETAILED DESCRIPTION

This technical solution is directed to a transfer device configured for mid-water docking to perform a seismic survey in an aqueous medium. Performing a seismic survey in an aqueous medium can include transferring sensors or other components from a marine vessel on the surface of an aqueous medium (e.g., an ocean or sea), to a bottom of the aqueous medium (e.g., ocean bottom, seabed, or sea floor). A transfer device can facilitating transferring, transporting or otherwise providing the sensors or other components from the surface of the aqueous medium to the bottom of the aqueous medium. For example, the transfer device can be placed on the deck of the marine vessel and then loaded with seismic sensors or other components. A crane on the deck of the marine vessel can lower transfer device into the aqueous medium, using a tether or cable. The crane can lower the transfer device to the seabed, at which point an underwater vehicle can retrieve the seismic sensors from the transfer device and place the seismic sensors directly on the seabed in order to collect seismic data.

Transfer devices that are powered can receive power from a marine vessel via an umbilical (e.g., tether or powered cable). Powered umbilical cables may require additional maintenance or care to prevent or damage or loss of power. When powered umbilical cables are damaged during operation, the transfer device may not be able to perform one or more functions that utilize power, and have to be retrieved to the vessel so that the umbilical cable can be replaced. Furthermore, powered umbilical cables can be heavier or bigger than an unpowered rope, thereby introducing more drag or friction as the umbilical cable is towed in the aqueous medium. This increased drag and friction can cause an increase in energy consumption (e.g., fuel use) by the marine vessel as well as make it more challenging to steer the transfer device through the aqueous medium, which can reduce the amount of time the marine vessel can result in wasted energy consumption.

The powered transfer device can be heavy which can require the use of a winch to lower and raise the transfer device. Using a winch can be cumbersome or inefficient as it can add additional steps or equipment to the process of performing the seismic survey. Using a winch or powered transfer device can also require crew members, or additional crew members, on board the marine vessel to operate or maintain the powered transfer device.

A powered transfer device, which can include complex electronics, motors or components, can require frequent maintenance, or require repairs when an electronic component fails. Furthermore, failure of an electronic component can cause delays in the seismic survey because the transfer device may be raised back to the deck of the marine vessel to be repaired or replaced.

Thus, systems, methods and apparatus of this technical solution provide an unpowered, mechanical gravity-based transfer device. The transfer device of this technical solution can operate in the aqueous medium without a powered umbilical cable connecting the transfer device to the marine vessel. Rather, the transfer device of this technical solution can be towed by the marine vessel with a rope or unpowered tether. The rope may not deliver power or have power delivery capabilities. The rope may also lack any data communication capabilities.

By using the unpowered, mechanical gravity-based transfer device of this technical solution, the seismic survey can be performed with less fuel or energy consumption because: 1) an unpowered transfer device can be lighter relative to a powered transfer device, 2) an unpowered robe can cause less drag or friction relative to a powered umbilical cable, and 3) there may be fewer delays due to maintenance or repairs of powered/electrical components of the transfer device or the umbilical cable.

The unpowered, mechanical gravity-based transfer device of this technical solution can include multiple chutes (or cassettes) that slope from one side of the transfer device to other side of the transfer device. An underwater vehicle can load a seismic sensor or other component into the chute such that the component slides, via gravity, from a higher end of the chute towards the lower end of the chute. The transfer device can include multipole chutes with alternating slopes such that multiple underwater vehicles can simultaneously load and or unload components. By simultaneously loading and/or unloading components from the transfer device, this technical solution can reduce the amount of time to deploy or retrieve seismic sensors, which can reduce the overall time to perform the seismic survey, thereby reducing energy consumption and improving the efficiency of the seismic survey.

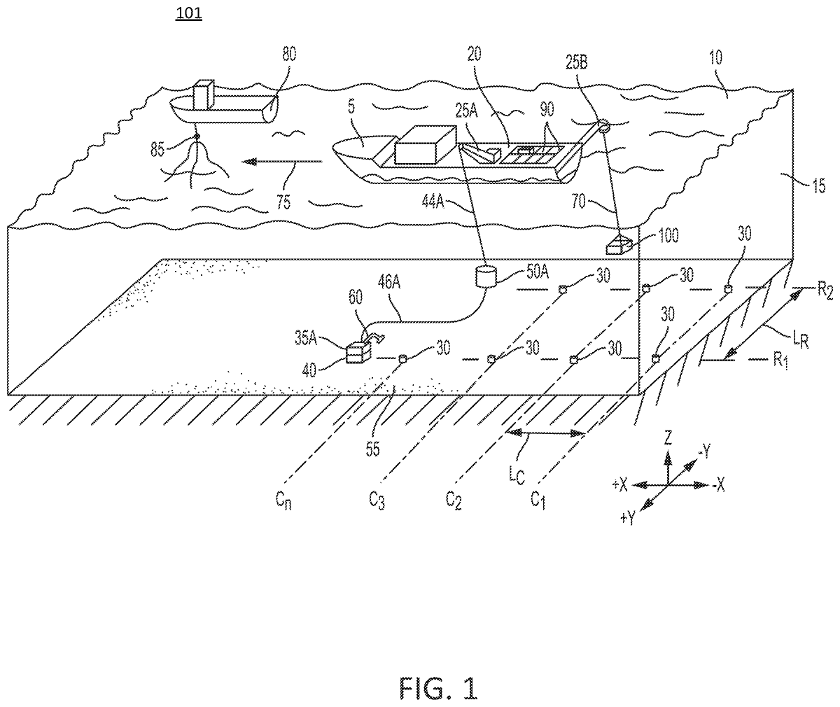

FIG. 1 is an isometric schematic view that illustrates a non-limiting example of an embodiment of a seismic operation or seismic survey. The seismic survey environment 101 can be an ocean bottom seismic survey in which seismic data acquisition units 30 can be deployed or placed on an ocean bottom. The seismic survey can be a mid-water seismic survey utilizing streamer seismic data acquisition units that can be mid-water or not on the ocean bottom and towed by the marine vessel 5. The seismic survey can be a land-based seismic survey. One more devices, systems, or components of the seismic survey environment 101 can be a cause of an extraneous noise source, including, for example, ocean waves, change in pressure, vibrations caused by mechanical features of or associated with the seismic data acquisition unit (e.g., a housing, rope, tether, cable, vessel, crane, or objects in the water). Other systems and survey operations outside of this survey can also be the source of the extraneous noise. For example, the environment 101 can include a third-party remote vessel not affiliated with the first vessel 5 that may be the source of extraneous noise.

One or more components or operations of the seismic survey environment 101 can be autonomous. For example, one or more operations, such as deployment or retrieval of sensors 30, can be performed autonomously. One or more components, such as the vessel 5, vessel 80, crane 25A, crane 25B, ROV 35A, acoustic source device 85, or seismic data acquisition unit 30 can be autonomous or perform one or more functionality automatically. The one or more autonomous components can perform an operation automatically and without human input during the performance of the operation. For example, the crane 25B can be programmed with instructions that allow the crane 25B to automatically lower the seismic sensor transfer device 100 through the water column 15 for mating with the ROV 35A. The ROV 35A can automatically retrieve the sensors 30 from the transfer device 100, and then automatically position or place the sensors 30 on the seabed. The source device 85 can automatically generate the seismic source, and the sensors 30 can record the seismic data. The ROV 35A can automatically retrieve the sensors 30 with the recorded seismic data, and automatically place the sensors 30 in the transfer device 100. The crane 25B can automatically retrieve the transfer device 100, and position the transfer device 100 on the deck 20 of the vessel 5 in order to remove the sensors 30 from the transfer device 100.

The seismic operation can be in deep water and facilitated by a first marine vessel 5. The first marine vessel 5 can be autonomous in that the first marine vessel 5 can be programmed or otherwise configured to depart from a location and move to a particular destination to deploy or retrieve seismic data acquisition units to facilitate the performance of a seismic survey, as well return back to the original departure location or some other location. The first vessel 5 is positioned on a surface 10 of a water column 15 and includes a deck 20 which supports operational equipment. At least a portion of the deck 20 includes space for a plurality of sensor device racks 90 where seismic sensor devices are stored. The sensor device racks 90 may also include data retrieval devices or sensor recharging devices.

The deck 20 also includes one or more cranes 25A, 25B attached thereto to facilitate transfer of at least a portion of the operational equipment, such as an ROV or seismic sensor devices, from the deck 20 to the water column 15. The cranes 25A and 25B can be autonomous in that the cranes 25A and 25B can be programmed or otherwise configured to automatically perform one or more operations. The crane 25A coupled to the deck 20 can lower and raise an ROV 35A, which transfers and positions one or seismic data acquisition units 30 on a seabed 55. The seabed 55 can include a lakebed 55, ocean floor 55, or earth 55. The ROV 35A can be wireless. The ROV 35A can be autonomous. The ROV 35A can be self-contained. The ROV 35A can be coupled to the first vessel 5 by, for example, a tether 46A and an umbilical cable 44A that provides power, communications, and control to the ROV 35A. A tether management system (TMS) 50A can be coupled between the umbilical cable 44A and the tether 46A. The TMS 50A can automatically provide one or more tether management functionalities. The TMS 50A may be utilized as an intermediary, subsurface platform from which to operate the ROV 35A. In some cases, for ROV 35A operations at or near the seabed 55, the TMS 50A can be positioned approximately 50 feet above seabed 55 and can pay out tether 46A for ROV 35A to move freely above seabed 55 to position and transfer seismic data acquisition units 30 thereon. Seismic data acquisition unit 30 can include a seismic sensor device or non-seismic sensor devices, as well as combinations thereof.

A crane 25B may be coupled (e.g., via a latch, anchor, nuts and bolts, screw, suction cup, magnet, or other fastener) to a stern of the first vessel 5, or other locations on the first vessel 5. Each of the cranes 25A, 25B may be any lifting device or launch and recovery system (LARS) adapted to operate in a marine environment. The crane 25B can be coupled to a seismic sensor transfer device 100 by a cable 70. The transfer device 100 can be an autonomous transfer device 100. The transfer device 100 may be a drone, a skid structure, a basket, or any device capable of housing one or seismic data acquisition units 30 therein. The transfer device 100 may be a structure configured as a magazine adapted to house and transport one or seismic data acquisition units 30. The transfer device 100 can be configured as a sensor device storage rack for transfer of sensor devices 30 from the first vessel 5 to the ROV 35A, and from the ROV 35A to the first vessel 5. The cable 70 may be an umbilical, a tether, a cord, a wire, a rope, and the like, that is configured to support the transfer device 100.

The ROV 35A can include a seismic sensor device storage compartment 40 that is configured to store one or more seismic data acquisition units 30 therein for a deployment or retrieval operation. The storage compartment 40 may include a magazine, a rack, or a container configured to store the seismic sensor devices. The storage compartment 40 may also include a conveyor, such as a movable platform having the seismic sensor devices thereon, such as a carousel or linear platform configured to support and move the seismic data acquisition units 30 therein. The seismic data acquisition units 30 may be deployed on the seabed 55 and retrieved therefrom by operation of the movable platform. The ROV 35A may be positioned at a predetermined location above or on the seabed 55 and seismic data acquisition units 30 are rolled, conveyed, or otherwise moved out of the storage compartment 40 at the predetermined location. In some embodiments, the seismic data acquisition units 30 may be deployed and retrieved from the storage compartment 40 by a robotic device 60, such as a robotic arm, an end effector or a manipulator, disposed on the ROV 35A. The robotic device 60 can be configured to autonomously perform one or more functions, such as retrieve a seismic data acquisition unit 30 from a transfer device 100, and position the seismic data acquisition unit 100 on the ocean floor or other desired location.

The seismic data acquisition unit 30 may include a sensor in an oil production field, and can be a seismic data acquisition unit or node. The seismic data acquisition unit 30 can record seismic data. Seismic data can include, for example, data collected by the one or more sensors of the device 30 such as trace data, force data, motion data, pressure data, vibration data, electrical current or voltage information indicative of force or pressure, temperature data, or tilt information. The seismic data acquisition unit 30 can include one or more sensors or components. The seismic data acquisition unit 30 may include one or more of at least one motion detector such as a geophone, at least one pressure detector such as a hydrophone, at least one power source (e.g., a battery, external solar panel), at least one clock, at least one tilt meter, at least one environmental sensor, at least one seismic data recorder, at least one global positioning system sensor, at least one wireless or wired transmitter, at least one wireless or wired receiver, at least one wireless or wired transceiver, or at least one processor. The seismic data acquisition unit 30 may be a self-contained unit such that all electronic connections are within the seismic data acquisition unit 30, or one or more components can be external to the seismic data acquisition unit 30. During recording, the seismic data acquisition unit 30 may operate in a self-contained manner such that the node does not require external communication or control. The seismic data acquisition unit 30 may include several geophones and hydrophones configured to detect acoustic waves that are reflected by subsurface lithological formation or hydrocarbon deposits. The seismic data acquisition unit 30 may further include one or more geophones that are configured to vibrate the seismic data acquisition unit 30 or a portion of the seismic data acquisition unit 30 in order to detect a degree of coupling between a surface of the seismic data acquisition unit 30 and a ground surface. One or more component of the seismic data acquisition unit 30 may attach to a gimbaled platform having multiple degrees of freedom. For example, the clock may be attached to the gimbaled platform to minimize the effects of gravity on the clock.

The device 30 can include or refer to other types of sensors, components, or units used in oilfield or hydrocarbon operations, production or exploration. The device 30 can record, detector, collect or obtain data related to oil field production or hydrocarbon production. The device 30 can collect data related to oil field production or hydrocarbon production that includes, for example, pressure information (e.g., pressure of oil or other fluid flowing through a pipe), temperature data (e.g., ambient temperature, temperature of a fluid flowing through a pipe, or temperature of a component or device), current flow (e.g., water flow or rate in an aqueous medium, river or ocean).

For example, in a deployment operation, a first plurality of seismic sensor devices, comprising one or seismic data acquisition units 30, may be loaded into the storage compartment 40 while on the first vessel 5 in a pre-loading operation. The ROV 35A, having the storage compartment coupled thereto, is then lowered to a subsurface position in the water column 15. The ROV 35A can utilize commands from personnel on the first vessel 5 to operate along a course to transfer the first plurality of seismic data acquisition units 30 from the storage compartment 40 and deploy the individual sensor devices 30 at selected locations on the seabed 55. Once the storage compartment 40 is depleted of the first plurality of seismic data acquisition units 30, the transfer device 100 is used to ferry a second plurality of seismic data acquisition units 30 as a payload from first vessel 5 to the ROV 35A.

The transfer system 100 may be preloaded with a second plurality of seismic data acquisition units 30 while on or adjacent the first vessel 5. When a suitable number of seismic data acquisition units 30 are loaded onto the transfer device 100, the transfer device 100 may be lowered by crane 25B to a selected depth in the water column 15. The ROV 35A and transfer device 100 are mated at a subsurface location to allow transfer of the second plurality of seismic data acquisition units 30 from the transfer device 100 to the storage compartment 40. When the transfer device 100 and ROV 35A are mated, the second plurality of seismic data acquisition units 30 contained in the transfer device 100 are transferred to the storage compartment 40 of the ROV 35A. Once the storage compartment 40 is reloaded, the ROV 35A and transfer device 100 are detached or unmated and seismic sensor device placement by ROV 35A may resume. Reloading of the storage compartment 40 can be provided while the first vessel 5 is in motion. If the transfer device 100 is empty after transfer of the second plurality of seismic data acquisition units 30, the transfer device 100 may be raised by the crane 25B to the vessel 5 where a reloading operation replenishes the transfer device 100 with a third plurality of seismic data acquisition units 30. The transfer device 100 may then be lowered to a selected depth when the storage compartment 40 is reloaded. This process may repeat as until a desired number of seismic data acquisition units 30 have been deployed.

Using the transfer device 100 to reload the ROV 35A at a subsurface location can reduce the time required to place the seismic data acquisition units 30 on the seabed 55, or “planting” time, as the ROV 35A is not raised and lowered to the surface 10 for seismic sensor device reloading. Further, mechanical stresses placed on equipment utilized to lift and lower the ROV 35A are minimized as the ROV 35A may be operated below the surface 10 for longer periods. The reduced lifting and lowering of the ROV 35A may be particularly advantageous in foul weather or rough sea conditions. Thus, the lifetime of equipment may be enhanced as the ROV 35A and related equipment are not raised above surface 10, which may cause the ROV 35A and related equipment to be damaged, or pose a risk of injury to the vessel personnel.

The sensor devices 30 can be placed on seabed 55 for an extended duration, such as 1 year, 2 years, 3 years, 4 years, 5 years, or more. Data, such as seismic data or status data, can be retrieved from the sensor devices 30 while they are located on the seabed 55 using wireless transmission techniques, such as optical links.

In a retrieval operation, the ROV 35A can utilize commands from personnel on the first vessel 5 to retrieve each seismic data acquisition unit 30 that was previously placed on seabed 55. In some cases, the ROV 35A can autonomously retrieve seismic data acquisition units 30 without having to receive commands from personnel on the first vessel 5. The retrieved seismic data acquisition units 30 are placed into the storage compartment 40 of the ROV 35A. In some embodiments, the ROV 35A may be sequentially positioned adjacent each seismic data acquisition unit 30 on the seabed 55 and the seismic data acquisition units 30 are rolled, conveyed, or otherwise moved from the seabed 55 to the storage compartment 40. In some embodiments, the seismic data acquisition units 30 may be retrieved from the seabed 55 by a robotic device 60 disposed on the ROV 35A.

Once the storage compartment 40 is full, contains a pre-determined number of seismic data acquisition units 30, or is otherwise ready, the transfer device 100 is lowered to a position below the surface 10 and mated with the ROV 35A. The transfer device 100 may be lowered by crane 25B to a selected depth in the water column 15, and the ROV 35A and transfer device 100 are mated at a subsurface location. The crane 25B can automatically lower the transfer device 100 for mating with the ROV 35A at the subsurface location. Once mated, the retrieved seismic data acquisition units 30 contained in the storage compartment 40 are transferred to the transfer device 100. Once the storage compartment 40 is depleted of retrieved sensor devices, the ROV 35A and transfer device 100 are detached and sensor device retrieval by ROV 35A may resume. Thus, the transfer device 100 is used to ferry the retrieved seismic data acquisition units 30 as a payload to the first vessel 5, allowing the ROV 35A to continue collection of the seismic data acquisition units 30 from the seabed 55. In this manner, sensor device retrieval time is significantly reduced as the ROV 35A is not raised and lowered for sensor device unloading. Further, safety issues and mechanical stresses placed on equipment related to the ROV 35A are minimized as the ROV 35A may be subsurface for longer periods.

The first vessel 5 may travel in a first direction 75, such as in the +X direction, which may be a compass heading or other linear or predetermined direction. The first vessel 5 can automatically travel in the first direction 75 based on initial instructions, input parameters, or navigation instructions. In some cases, the first vessel 5 can automatically select or determine the first direction 75 based on receiving a coordinates for a destination. The first direction 75 may also account for or include drift caused by wave action, current(s) or wind speed and direction. In one embodiment, the plurality of seismic data acquisition units 30 are placed on the seabed 55 in selected locations, such as a plurality of rows Rn in the X direction (R1 and R2 are shown) or columns Cn in the Y direction (C1-Cn are shown), wherein n equals an integer. In one embodiment, the rows Rn and columns Cn define a grid or array, wherein each row Rn (e.g., R1-R2) comprises a receiver line in the width of a sensor array (X direction) or each column Cn comprises a receiver line in a length of the sensor array (Y direction). The distance between adjacent sensor devices 30 in the rows is shown as distance LR and the distance between adjacent sensor devices 30 in the columns is shown as distance LC. While a substantially square pattern is shown, other patterns may be formed on the seabed 55. Other patterns include non-linear receiver lines or non-square patterns. The pattern(s) may be pre-determined or result from other factors, such as topography of the seabed 55. The distances LR and LC may be substantially equal and may include dimensions between about 60 meters to about 400 meters, or greater. The distance between adjacent seismic data acquisition units 30 may be predetermined or result from topography of the seabed 55 as described above.

The first vessel 5 can be operated at a speed, such as an allowable or safe speed for operation of the first vessel 5 and any equipment being towed by the first vessel 5. The first vessel 5 can automatically determine the speed at which to operate based on various factors or conditions in real-time or during operation. The speed may take into account any weather conditions, such as wind speed and wave action, as well as currents in the water column 15. The speed of the vessel may also be determined by any operations equipment that is suspended by, attached to, or otherwise being towed by the first vessel 5. For example, the speed can be limited by the drag coefficients of components of the ROV 35A, such as the TMS 50A and umbilical cable 44A, as well as any weather conditions or currents in the water column 15. The first vessel 5 can automatically determine the speed limit based on such drag coefficients. As the components of the ROV 35A are subject to drag that is dependent on the depth of the components in the water column 15, the first vessel speed may operate in a range of less than about 1 knot. In this embodiment, wherein two receiver lines (rows R1 and R2) are being laid, the first vessel includes a first speed of between about 0.2 knots and about 0.6 knots. In other embodiments, the first speed includes an average speed of between about 0.25 knots, which includes intermittent speeds of less than 0.25 knots and speeds greater than about 1 knot, depending on weather conditions, such as wave action, wind speeds, or currents in the water column 15.

During a seismic survey, one receiver line, such as row R1 may be deployed. When the single receiver line is completed a second vessel 80 is used to provide a source signal. The second vessel 80 is provided with a source device or acoustic source device 85, which may be a device capable of producing acoustical signals or vibrational signals suitable for obtaining the survey data. The source signal propagates to the seabed 55 and a portion of the signal is reflected back to the seismic data acquisition units 30. The second vessel 80 may be required to make multiple passes, for example at least four passes, per a single receiver line (row R1 in this example). During the time the second vessel 80 is making the passes, the first vessel 5 continues deployment of a second receiver line. However, the time involved in making the passes by the second vessel 80 may be much shorter than the deployment time of the second receiver line. This causes a lag time in the seismic survey as the second vessel 80 sits idle while the first vessel 5 is completing the second receiver line. The first vessel 5, second vessel 80, and acoustic source device 85 can perform one or more operations of the seismic survey autonomously and without human or manual input or commands during the seismic operation. For example, the first vessel 5, second vessel 80 and acoustic source device 85 can automatically communicate with one another to orchestrate one or more travel paths or sequences and generating acoustic or vibrational signals suitable for obtaining seismic data.

The first vessel 5 can use one ROV 35A to lay sensor devices to form a first set of two receiver lines (rows R1 and R2) in any number of columns, which may produce a length of each receiver line of up to and including several miles. The two receiver lines (rows R1 and R2) can be parallel or substantially parallel (e.g., less than 1 degree off parallel, 2 degrees off parallel, 0.5 degrees off parallel, 0.1 degrees off parallel, or 5 degrees off parallel). When a single directional pass of the first vessel 5 is completed and the first set (rows R1, R2) of seismic data acquisition units 30 are laid to a predetermined length, the second vessel 80, provided with the source device 85, is utilized to provide the source signal. The second vessel 80 can make eight or more passes along the two receiver lines to complete the seismic survey of the two rows R1 and R2.

While the second vessel 80 is shooting along the two rows R1 and R2, the first vessel 5 may turn 180 degrees and travel in the X direction in order to lay seismic data acquisition units 30 in another two rows adjacent the rows R1 and R2, thereby forming a second set of two receiver lines. The second vessel 80 may then make another series of passes along the second set of receiver lines while the first vessel 5 turns 180 degrees to travel in the +X direction to lay another set of receiver lines. The process may repeat until a specified area of the seabed 55 has been surveyed. Thus, the idle time of the second vessel 80 is minimized as the deployment time for laying receiver lines is cut approximately in half by deploying two rows in one pass of the vessel 5.

Although only two rows R1 and R2 are shown, the seismic data acquisition unit 30 layout is not limited to this configuration as the ROV 35A may be adapted to layout more than two rows of sensor devices in a single directional tow. For example, the ROV 35A may be controlled to lay out between three and six rows of sensor devices 30, or an even greater number of rows in a single directional tow. The width of a “one pass” run of the first vessel 5 to layout the width of the sensor array can be limited by the length of the tether 46A or the spacing (distance LR) between sensor devices 30.

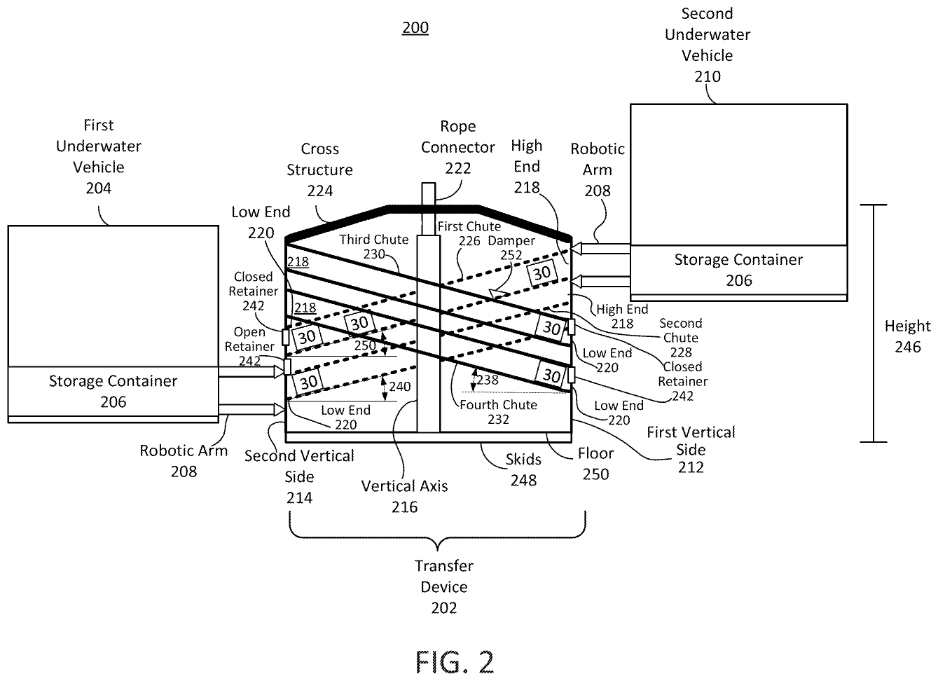

FIG. 2 depicts an illustration of a side view of a transfer device with multiple chutes to perform a seismic survey in an aqueous medium, in accordance with an implementation. The system 200 can include a transfer device 202. The transfer device 202 can include one or more component or perform one or more functionality of transfer device 100. The transfer device 202 can be used in conjunction with transfer device 100, or can replace transfer device 100. The transfer device 202 can be used in system 101 instead of transfer device 100. For example, the transfer device 202 can be lowered into the aqueous medium by crane 25B on marine vessel 5 via a cable 70, which can be an unpowered rope. An underwater vehicle (e.g., an ROV 35A, autonomous underwater vehicle, or other underwater vehicle) can retrieve components from the transfer device 202, or load components into the transfer device 202. In some cases, the transfer device 202 can be located on an underwater vehicle, such as on an autonomous underwater vehicle.

The transfer device 202 can have minimal mechanical components and largely operate based on gravity. The transfer device 202 can have multiple chutes (e.g., 226, 228, 230 and 232) that are each sloped. Each chute 226-232 can have a high end 218 and a low end 220 that is opposite the high end 218. Each end (e.g., high end 218 or low end 220) of each chute (226-232) can be engaged by an underwater vehicle (e.g., first underwater vehicle 204 or second underwater vehicle 210). The underwater vehicle can refer to or include an remotely operated vehicle, autonomous underwater vehicle, or other type of vehicle or robot. The underwater vehicle can engage with an end in order to load components into the transfer device 202, or retrieve components from the transfer device. For example, the second underwater vehicle 210 can engage with high end 218 of the first chute 226 in order to load sensors 30 (or other components) on to the transfer device 202. By engaging with the high end 218, the sensors 30 can move away from the second underwater vehicle 210 via gravity as they are loaded onto the first chute 226. The first underwater vehicle 204, for example, can engage with the low end 220 of the second chute 228 in order to retrieve sensors 30 from the transfer device 202. By engaging with the low end 220 of the second chute 228, the sensors 30 can move towards the first underwater vehicle 204 via gravity as they are on-loaded to the first underwater vehicle 204.

The transfer device 202 can include one or more chutes. The chutes can be referred to as cassettes. The transfer device 202 can include two chutes, three chutes, four chutes, five chutes, six chutes, seven chutes, eight chutes, or more chutes. The transfer device 202 can include one or more groups of aligned chutes. A group of aligned chutes can refer to multiple chutes having a high end located on a same side and a low end located on a same opposite side. A group of aligned chutes can have can extend from one vertical side to the opposite vertical side with a slope or angle such that the chute does not intersect or contact another chute in the same group of chutes. For example, chutes in the same group of aligned chutes can have a same slope or angle (e.g., substantially same slop or angle to within 1%, 2%, 2%, 3%, 4%, 5%, 7%, 9%, 10%, or 15% for example).

The transfer device can include array of cassettes or chutes arranged as groups of aligned of cassettes or chutes. For example, the transfer device can include an array of 8 cassettes as arranged as 2 groups of 4 aligned cases. Each group can include of 4 cassettes sloped in the same direction and arranged 2 high×2 side. The 2 groups can differ in that the slope can be reversed between the 2 groups. For example, if group 1 (e.g., chutes 226 and 228) has high ends 218 on the first vertical side 212, and low ends 220 on the second vertical side 214, then group 2 (e.g., chutes 230 and 232) can have high ends 218 on the second vertical side 214 and low ends 220 on the first vertical side 212. This arrangement can allow access to both sides of the transfer device 202 at the same time, which can allow an underwater vehicle to take nodes from the transfer device 202 for deployment or return nodes to the transfer device 202 for retrieval. Thus, by including one or more pairs of reverse chutes, the transfer device 202 can be: i) on-loaded simultaneously or in an overlapping fashion by multiple underwater vehicles 204 and 210, ii) off-loaded simultaneously or in an overlapping fashion by multiple underwater vehicles 204 and 210, or iii) off-loaded by a first underwater vehicle in a simultaneous or overlapping manner as being on-loaded by a second underwater vehicle. Further, by establishing an unpowered transfer device 202 with a weight above a threshold, the transfer device 202 can be towed in a stable manner behind the marine vessel 5 using the vessel's crane 25B. The transfer device 202 can be towed by a crane 25B as opposed to a side-mounted launch and recovery system that may be used to deploy powered transfer devices or underwater vehicles.

Still referring to FIG. 2, and in further detail, the transfer device 202 can include a first vertical side 212. The transfer device can include a second vertical side 214 that is opposite the first vertical side 212. The first vertical side 212 and the second vertical side 214 can extend from a floor 250 of the transfer device 202. The floor 250 can be at the bottom of the transfer device 202. The first and second vertical sides 212 and 214 can be at opposite ends of the floor 250 of the transfer device 202. The first and second vertical sides 212 and 214 can extend perpendicularly or at a 90 degree angle from the floor 250. The first and second vertical sides 212 and 214 can extend at a different angle from the floor 250, such as at an angle of 70 degrees, 80 degrees, 85 degrees, 95 degrees, 100 degrees or other angle.

The transfer device 202 can include a floor 250 that forms a foundation or platform for the transfer device 202. The floor 250 can be a planar shape, such as a square or rectangular. The floor 250 can be circular, elliptical, or form a polygonal shape. The floor 250 can be flat, concave, or convex. For example, the floor 250 can be a rectangular plane in an x-y coordinate with four sides that connect at 90 degree angles. The first vertical side 212 can extend perpendicularly in a z-axis that is perpendicular to the x-y axis of the floor 250. The first vertical side 212 can extend from one side of the floor 250, while the second vertical side 214 extend in the z-direction from an opposite side.

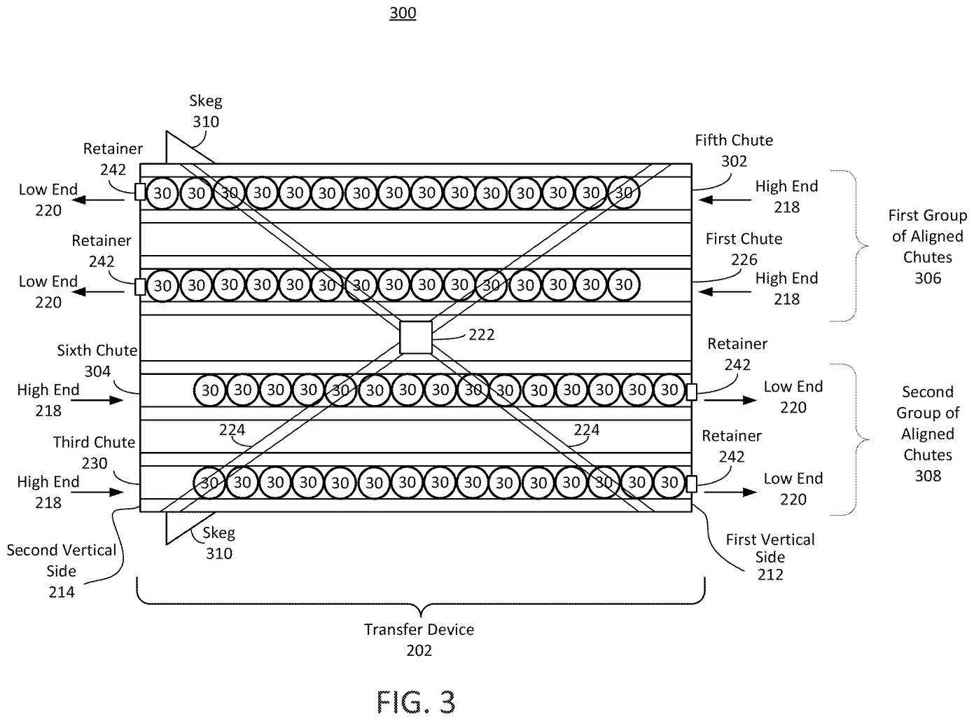

The first and second vertical sides 212 and 214 can extend from the floor 250 towards a cross structure 224 or other ceiling of the transfer device 202. The transfer device 202 can include a cross structure 224 that can provide structural integrity for the transfer device 202. The cross structure 224 can include any type of structure or shape that provides a ceiling that can provide structural integrity for the first and second vertical sides 212 and 214 that extend from the floor 250. The cross structure 224 can form an X by including two diagonal structures that extend diagonally above the floor 250, as depicted in FIG. 3. The cross structure 224 can be any type of structure. For example, the cross structure 224 can be or include one or more horizontal structures or beams that extend from the first vertical side 212 to the second vertical side 214. The cross structure 224 can mechanically couple the first vertical side 212 with the second vertical side 214.

The transfer device 202 can include a rope connector 222. The rope connector 222 can be affixed to a portion of the transfer device 202. The rope connector 222 can couple a first end of a rope to the transfer device 202. A second end of the rope can couple to a component on a marine vessel 5 to tow the transfer device 202 through the aqueous medium.

The rope connector 222 can be located or positioned on a top side of the transfer device 202. The top side of the transfer device can refer to a side external to the transfer device 202 or above the transfer device 202. The rope connector 222 can be located above the cross structure 224. The rope connector 222 can include a coupling mechanism to couple or connect with a rope. The coupling mechanism can include a loop, ring, latch, clasp, or other types of rope coupling mechanisms. The rope can engage or couple with the rope connector 222 such that the rope can be disengaged from the rope connector 222 at a subsequent time without damaging the rope or the rope connector.

The rope connector 222 can couple the transfer device 202 to a marine vessel 5 via a rope or cable 70. The rope can be unpowered. The rope may not include power delivery or data communication capabilities. The rope connector 222 can couple the transfer device 202 to a crane 25B on the marine vessel via a rope 70 such that the marine vessel 5 can tow the transfer device 202 behind the marine vessel 5. The marine vessel 5 can tow the transfer device immediately or directly behind the marine vessel 5, such as within an arc formed by an angle behind the marine vessel 5, such as 10 degrees, 20 degrees, 30 degrees, 40 degrees, 50 degrees 60 degrees, or 90 degrees.

The transfer device 202 can include one or more chutes (or cassettes), such as a first chute 226, second chute 228, third chute 230, and fourth chute 232. The transfer device 202 can include two or more chutes. For example, the transfer device 202 can include 8 chutes that are formed by two groups of 4 aligned chutes. FIG. 2 depicts a side view of a transfer device 202 containing at least 2 groups of 2 aligned chutes. The first group of aligned chutes can include first chute 226 and second chute 228. The first group of aligned chutes 226 and 228 are depicted in dashed lines to illustrate that the first group of aligned chutes are located behind the second group of aligned chutes 230 and 232 relative to the side view 200 depicted in FIG. 2. The second group of aligned chutes can include third chute 230 and fourth chute 232. The first group of aligned chutes can have a reverse (or opposite) slope relative to the second group of aligned chutes.

The transfer device 202 can include a first chute 226. The first chute 226 can receive one or more sensors 30 or other components or units. The sensors 30 can slide from the high end 218 of the first chute 226 towards the low end 220 of the first chute 226 via gravity. For example, the first chute 226 can be sloped at an angle to cause the sensors 30 slide from the high end 218 of the first chute 226 towards the low end of the first chute 226. The first chute 226 can extend from the first vertical side 212 towards the second vertical side 214 and traverse a vertical axis 216 of the transfer device 202. The vertical axis 216 can extend perpendicularly from the floor 250 of the transfer device 202 towards the rope connector 222, cross structure 224 or other ceiling of the transfer device. The vertical axis 216 can be parallel to the first vertical side 212 or the second vertical side 214.

The first chute 226 can slope downwards from the first vertical side 212 to the second vertical side 214 with a slope or angle 250 such that the high end 218 of the first chute 226 is further from the floor 250 of the transfer device relative to the low end 220 of the first chute 226. The angle 250 with which the first chute slopes downward from the first vertical side 212 to the second vertical side 214 can be, for example, 25 degrees, 30 degrees, 45 degrees, 50 degrees or some other angle. The high end 218 can be higher off the floor 250 of the transfer device 202 than the low end 220 is off the floor 250 of the transfer device. By sloping downwards from the first vertical side 212 to the second vertical side 214, sensors that are on-loaded to the first chute 226 can slide from the first vertical side 212 towards the second vertical side 214 based on gravity.

The first chute 226 can be formed of a material that provides a coefficient of friction that allows the sensors 30 to slide via gravity from the high end 218 of the first chute 226 towards the low end 220 of the first chute 226. The first chute 226 can be formed of a material that allows the sensors 30 to slide via gravity while submerged in an aqueous medium, such as sea water or ocean water. The first chute 226 can be coated with a material or substance that can reduce the coefficient of friction between the first chute 226 and the sensors 30 in order to facilitate sliding of the sensors 30 from the high end 218 towards the low end 220. The substance can include a lubrication, such as oil or grease, or other type of lubricant. In some cases, to facilitate the sensors 30 sliding from the high end 218 towards the low end 220, the first chute 226 can include mechanical rollers or a mechanical conveyor. The mechanical rollers or mechanical conveyer can be unpowered and facilitate the sensors 30 sliding down the first chute 226 via gravity. Thus, sensors 30 can move from the high end 218 of the first chute 226 towards the low end 220 of the first chute 226 via gravity based on an angle of the slope of the first chute 226 and a configuration of the material or mechanical conveyors of the first chute 226.

The angle 250 and coefficient of friction (or mechanical conveyors) of the first chute 226 can be configured or established such that the sensors 30 travel from the first vertical side 212 towards the second vertical side 214 at a desired speed. Sensors 30 travelling down the first chute 226 at a high speed can cause damage to other sensors, the retainer 242 or other component of the transfer device 202. Accordingly, the slope and coefficient of friction or mechanical rollers can be configured to control the speed with which sensors 30 can travel down the first chute 226. For example, if the angle 250 is high (e.g., greater than 45 degrees), then the coefficient of friction of the first chute 226 can be increased in order to dampen, reduce, or attenuate the speed at which the sensors 30 slide down the first chute 226. If, however, the angle 250 of the first chute 226 is low (e.g., less than 30 degrees), then the coefficient of friction can be decreased to facilitate the sensors 30 sliding down the first chute 226 at a desired speed so as not to introduce delays in on-loading or off-loading sensors 30 from the transfer device 202. Thus, if the angle 250 is higher, the coefficient of friction of the first chute 226 can also be configured to be higher or the first chute 226 can be configured to include a dampening mechanism to reduce the rate at which sensors 30 slide down the first chute 226. If the angle 250 is lower, then the coefficient of friction of the first chute 226 can also be lower so as to allow the sensors 30 slide down the first chute 226 at a desired speed.

The transfer device 202 can include one or more dampers 252 designed, constructed and operational to dampen the rate at which the sensors 30 travel down the chutes 226-232. Each chute 226-232 can include one or more dampers 252. The one or more dampers 252 can be positioned anywhere on the chutes 226-232 to slow down the rate at which the sensors 30 travel down the chutes. For example, the first chute 226 can include a damper 252 located approximately a quarter of the way down the first chute 226 from the first vertical side 212. The damper 252 can be located halfway down the first chute 226, three-quarters of the way down the first chute 226, or anywhere else on the first chute 226.

The damper 252 can include a spring mechanism that can absorb the kinetic energy of the sensor 30 sliding down the first chute 226. The kinetic energy of the sensors 30 can be transferred to the spring mechanism of the damper 252 to cause the damper 252 to contract or be squeezed, thereby converting the kinetic energy of the sensor 30 to potential energy of the damper 252. Once the sensor 30 passes over the damper 252, the spring mechanism can recoil and release the stored potential energy that had been transferred from the sensor 30. In some cases, the spring mechanism can include a foam or sponge-like material that can absorb kinetic energy to be stored temporarily as potential energy, and then release the potential energy. Thus, the transfer device 202 can include a damper 252 configured to dampen a rate at which sensors 30 (or other units or components) slide down a chute from a high end to the low end of the chute.

The transfer device 202 can include a second chute 228 that can receive one or more sensors 30. The second chute 228 can have a high end 218 and a low end 220. The high end 218 of the second chute 228 can be located on the first vertical side 212. The low end 220 of the second chute 228 can be located on the second vertical side 214. The distance between the high end 218 and the floor 250 is greater than the distance between the low end 220 and the floor 250.

The second chute 228 can be located directly below the first chute 226. For example, if the high end 218 of the first chute 226 is at a first height relative to the floor 250, then the high end 218 of the second chute 228 can be at a second height that is less than the first height. The difference between the first height and the second height can be based on the dimensions of the first chute 226 and second chute 228, the dimensions of the sensors 30 or other components to be on-loaded to the transfer device 202, the retainer 242 mechanism, or based on an amount of clearance that facilitates the underwater vehicle to engage with the chute.

The second chute 228 and the first chute 226 can be in a same vertical axis that extends from the floor 250 towards the cross structure 224. In some cases, the first chute 226 and the second chute 228 can be offset from one another relative to the vertical axis such that the chutes do not overlap or are not above one another. The first chute 226 and the second chute 228 can be in a different horizontal axis, where the horizontal axis extends from the first vertical side 212 to the second vertical side 214.

Thus, the first chute 226 and the second chute 228 can be in a same or similar vertical axis, while being offset in a horizontal axis. The first chute 226 and the second chute 228 can be aligned in that they may be parallel to one another as they extend from the first vertical side 212 to the second vertical side 214. The first chute 226 and the second chute 228 can be parallel in that they do not intersect one another from the side view perspective depicted in FIG. 2. For example, the second chute 228 can have a slope that matches the first chute 226. The slopes of the first and second chutes can match to within 1%, 2%, 3%, 4%, 5%, 10% or other percentage such that the two chutes do not intersect one another and provide sufficient clearance for sensors 30 or other components to slide down the chutes without interference from another chute.

The transfer device 202 can include additional chutes that are parallel to the first chute 226 and the second chute 228. For example, the transfer device 202 can include three chutes, four chutes or more that are aligned and grouped together similar to the first chute 226 and the second chute 228. The additional chutes can be stacked above or below the first chute 226 and the second chute 228, provided there is sufficient room for the additional chutes available in the transfer device 202 between the floor 250 and the cross structure 224.

The transfer device 202 can include a second group of aligned chutes (e.g., third chute 230 and fourth chute 232) that have a reverse slope relative to the first group of aligned chutes (e.g., first chute 226 and second chute 228). The second group of aligned chutes can be similar to the first group of aligned chutes, except for their slope and which vertical side their respective high ends 218 and low ends 220 are located. For example, the transfer device 202 can include a third chute 230 with a high end 218 located on the second vertical side 214, and the low end 220 located on the first vertical side. The transfer device 202 can include a fourth chute 232 with a high end 218 located on the second vertical side 214, and the low end located on the first vertical side 212. The third chute 230 can be located above the fourth chute 232 in a vertical axis that extends from the floor 250 to the cross structure 224 or other ceiling of the transfer device 202 such that the third chute 230 and the fourth chute 232 do not intersect with one another. The third chute 230 and the fourth chute 232 can be aligned and have a matching slope, such as based on the angle 238. The angle 238 can represent the angle of the fourth chute 232 relative to the floor 250

The absolute slope of the fourth chute 232 and the second chute 228 can be the same or substantially similar. However, when determine from a common frame of reference, the slope of the second chute 228 can be the opposite or reverse to the slope of the fourth chute 232. For example, if the slope if the second chute 228 is ¼, then the slope of the fourth chute 232 can be −¼.

While the slopes of the first group of aligned chutes can be the opposite of the slopes of the second group of aligned chutes, the chutes can be positioned or located in the transfer device 202 such that the chutes do not contact or intersect with one another within the transfer device 202, while also providing sufficient clearance for sensors 30 to slide down the chutes. For example, the first group of aligned chutes 226 and 228 can be offset from the second group of aligned chutes 230 and 232 such that the two groups of aligned chutes to do not intersect or contact one another.

The transfer device 202 can include one or more retainers 242 at one or more ends of one or more chutes. The retainer 242 can close or cover an end of a chute. The retainer 242 can be a mechanical gate, door, blockade, obstacle, barrier, or other structure that can close an end of a chute (e.g., 226-232) such that sensors 30 do not inadvertently fall out of the chute and can be contained within the chute. The retainer 242 can be configured to prevent debris, dirt, marine life, or other substances from entering the chute when the retainer 242 is closed.

In some cases, the retainer can be located only at the low end 220 of each chute 226-232, but not the high end 218. In some cases, the retainer can be located at both the low end 220 and the high end 218 of each chute 226-232.

The retainer 242 can be mechanically operated. The retainer 242 can be operated without using any power or energy from the transfer device 202. The transfer device 202 can be unpowered and not receive any power from the marine vessel 5 or via any rope or cable used to tow the transfer device 202. Thus, this technical solution can include a retainer 242 that can be operated by an external robotic arm 208 without requiring any power or energy consumption from the transfer device 202. For example, the retainer 242 can include gravity gates that can close when released by the robotic arm of the 208 due to gravity. The weight of the gravity gates can cause the gate to close by the force caused by gravity and without any other force mechanism.

For example, a first underwater vehicle 204 can mate with the transfer device 202 at the low end 220 of the second chute 228. The first underwater vehicle 204 can engage with the low end 220 using the robotic arm 208. The robotic arm 208 can include one or more component, system or function of robotic arm 60 depicted in FIG. 1. The first underwater vehicle 204 can control the robotic arm 208 to lift the retainer 242 into an open position. The retainer 242 can stay in the open position. The retainer 242 an include a locking mechanism to stay in the open position until the robotic arm 208 closes the retainer 242. In some cases, the robotic arm 208 can hold the retainer 242 in the open position. Once the robotic arm 208 releases the retainer 242, the retainer 242 can be constructed to automatically close in order to seal or cover the low end 220 of the second chute 228, or otherwise prevent unwanted substances from entering the low end 220 of the second chute 228, while also preventing any remaining sensors 30 from sliding out of the low end 220 of the second chute 228.

The retainer 242 can include a spring mechanism that causes the retainer 242 to stay in a default position (e.g., open or closed). For example, the spring mechanism can cause the retainer 242 to stay in the closed position until a robotic arm 208 opens the retainer. When the robotic arm 208 releases the retainer 242, the spring mechanism can cause the retainer 242 to bounce back into the closed position.

In some cases, the retainer 242 can include a pulley mechanism or counterweight mechanism that is designed, constructed and operational to keep the retainer 242 in a closed position until opened by the robotic arm 208. The retainer 242 can include a locking mechanism to keep the retainer 242 closed, or open. The robotic arm 208 can be configured to unlock the retainer 242 in order to open the retainer 242, or close the retainer 242. The robotic arm 208 an include a latch and one or more pins used to mate the robotic arm 208 or underwater vehicle 204 or 210 with the transfer device 202 during on-loading or off-loading of sensors 30 to or from the transfer device. The underwater vehicle 204 can mate with the high end 218 or low end 220 of a chute by latching onto a portion of the transfer device 202 and locking the latch with a pin so as to securely mate with an end 218 or 220 of the transfer device 202. Once mated, and the latch is locked with pins, the robotic arm 208 of the underwater vehicle 204 or 210 can actuate the retainer 242 to open the retainer.

The first underwater vehicle 204 can retrieve sensors 30 from one or more low ends 220 of one or more chutes 226-232 by opening the retainer 242. When the robotic arm 208 opens the retainer 242, one or more sensors 30 can slide out of the chute based on gravity. The first underwater vehicle 204 can retrieve the one or more sensors 30 and store the one or more sensors in a storage container 206. The storage container 206 can be located within the first underwater vehicle 204. The first underwater vehicle 204 can then travel to a location on the seabed in order to place the sensor 30 on the seabed. The sensor 30 can contact the seabed, ocean floor or other bottom surface of the aqueous medium. The sensors 30 can couple with the seabed. The sensors 30 detect seismic signals and record seismic data. The sensors 30 can collect seismic data corresponding to signals reflected or refracted off subsurface features. The sensors 30 can collect any type of data, including, for example, earthquake detection information, temperature information, turbidity information, ocean current information, seabed subsidence information, salinity information, water quality information, ambient noise information, etc. The sensors 30 can be any type of instrument designed, constructed and operational to collect any type of data. Thus, the transfer device 202 can present, at the low end 220 of a chute, sensors 30 or other components to an underwater vehicle for deployment on a seabed.

A second underwater vehicle 210 can on-load sensors 30 or other components to the transfer device 202. If the transfer device 202 includes a retainer 242 on the high end 218, the second underwater vehicle 210 can use a robotic arm 208 to open the retainer 242. The second underwater vehicle 210 can transfer one or more sensors from a storage container 206 of the second underwater vehicle 210 to the first chute 226. The sensors 30 can enter the first chute 226 at the high end 218, and then slide down the first chute 226 towards the low end 220. The second underwater vehicle 210 can transfer multiple sensors until the first chute 226 is full.

If the second underwater vehicle 210 has additional sensors 30 to load onto the transfer device 202 after the first chute 226 is full, the second underwater vehicle 210 can engage with a different high end 218 of the transfer device 202. For example, the second underwater vehicle 210 can engage with high end 218 of the second chute 228, and then load additional sensors 30 onto the transfer device 202 via the second chute 228. Thus, the transfer device 202 can receive, at the high end 218 of a chute, sensors 30 or other components from an underwater vehicle. In some cases, the transfer device 202 can be loaded while transfer device 202 is located on the deck 20 of the marine vessel 5, and receive the sensors 30 from a conveyor on a device rack 90 on the marine vessel.

The transfer device 202 can receive sensors at multiple high ends 218 in a simultaneous or overlapping fashion. For example, the transfer device 202 can be on-loaded with sensors via high end 218 of the first chute 226 at the same as the transfer device 202 is on-loaded with sensors 30 from the high end 218 of the third chute 230. Since multiple conveyors or underwater vehicles may not be able to engage with corresponding high ends 218 on a same vertical side 212 or 214 at the same time, the transfer device 202 can be on-loaded simultaneously via high ends 218 located on opposite sides 212 and 214, for example.

The transfer device 202 can include one or more skids 248 located on a bottom of the transfer device 202. The skids 248 can be located below the floor of the transfer device 202. The skids 248 can be formed of wood, metal, plastic, rubber, or other material. For example, the skids 248 can be made of wood. The skids 248 can be made of a heavy material or be weighted in order to provide stabilization for the transfer device 202, orient the transfer device 202, or help the transfer device 202 maintain balance in the aqueous medium. The transfer device 202 can be placed on the skids 248 when on the deck 20 of the marine vessel 5. The skids 248 can extend along some or all of the footprint of the transfer device 202.

The transfer device 202 and its components can be formed of, include, coated with or otherwise manufactured with any type of materials that are conducive to performing underwater survey operations. Materials can include metals, alloys, aluminum, plastics, rubber, fiberglass, glass, or other materials. For example, the entire transfer device 202 can be built from steel, including the cross structure, chutes, and retainers.

The height 246 of the transfer device 202 can be an amount that provides the transfer device 202 sufficient room to hold chutes with a sufficient slope that allows the sensors 30 to slide via gravity from a high end 218 to a low end 220 at a desired speed or rate. For example, the height 246 of the transfer device 202 can be 12 feet, 10 feet, 9 feet, 13 feet, 14 feet, 15 feet, or other amount. The height 246 can be measured from the floor 250 to the cross structure 224. The height 246 can be measured from the bottom of the skids 248 to the topmost portion of the cross structure 224. The height 246 can be measured to include the rope connector 222 or the skids 248, for example.

FIG. 3 depicts an illustration of a top view of a transfer device with multiple chutes to perform a seismic survey in an aqueous medium, in accordance with an implementation. The top view 300 of the transfer device 202 can include one or more component, system, or functionality depicted in FIG. 2, including, for example, the transfer device 202, chutes, high ends 218, low ends 220, the cross structure 224, and rope connector 222.

As depicted in the side view 300 of the transfer device 202, the transfer device 202 can include two groups of aligned chutes: a first group of aligned chutes 306 and a second group of aligned chutes 308. The first group of aligned chutes 306 can include the first chute 226, as depicted in FIGS. 2 and 3. The first group of aligned chutes 306 can also include the second chute 228 as depicted in FIG. 2. The second chute 228 may not be depicted in the top view 300 of FIG. 3 because the second chute 228 can be below the first chute 226, thereby obscuring the second chute 228 from view when perceived from the top side. However, the top side view 300 can illustrate the fifth chute 302 as part of the first group of aligned chutes 306. the fifth chute 302 may not have been illustrated from the side view 200 depicted in FIG. 2 because the fifth chute 302 may have been obscured from a side view by the first chute 226. Similar to the second chute 228, the transfer device 202 can include an additional aligned chute below the fifth chute 302. This additional aligned chute can be obscured from view in both the top view 300 and the side view 200. Thus, the first group of aligned chutes 306 can include four chutes.

The first group of aligned chutes 306 can share one or more characteristics have one or more characteristics in common. For example, the chutes in the first group of aligned chutes 306 can all have a high end 218 located on the first vertical side 212 and a low end 220 located on the second vertical side 214. The chutes in the first group of aligned chutes 306 can have a same or similar (e.g., within 1%, 2%, 3%, 5%, 6%, 7%, or 10%) slope. The chutes in the first group of aligned chutes 306 can be grouped proximate to one another, such as one side of the transfer device 202.

The transfer device 202 can include a second group of aligned chutes 308. The second group of aligned chutes 308 can include the third chute 230, which is also illustrated in the side view 200 depicted in FIG. 2. The second group of aligned chutes 308 can include the fourth chute 232, which is illustrated in the side view 200 of FIG. 2, but can be obscured from view by the third chute 230 in the top view 300 depicted in FIG. 3. The second group of aligned chutes 308 can include a sixth chute 304. The sixth chute 304 can be viewed in the top view 300, but may be obscured from view by the fourth chute 232 in the side view 200 illustrated in FIG. 2. The second group of aligned chutes 308 can include an additional chute that may be obscured from view by the sixth chute 304. This additional chute can be obscured from view in both the top view 300 and the side view 200. Thus, the second group of chutes 308 can include four chutes.

The chutes in the second group of aligned chutes 308 can share one or more characteristics in common with one another. For example, the chutes in the second group of aligned chutes 308 can each have a high end 218 located on the second vertical side 214, and can each have a low end 220 located on the first vertical side 212. The chutes in the second group of aligned chutes 308 can have a same or similar (e.g., within 1%, 2%, 3%, 5%, 6%, 7%, or 10%) slope. However, the slope of the chutes in the second group of aligned chutes 308 can be the reverse or opposite the slope of the chutes in the first group of aligned chutes 306. The chutes in the second group of aligned chutes 308 can be proximate to another, such as on a same side or portion of the transfer device 202. Thus, the transfer device 202 can include two groups of aligned chutes 306 and 308 that can each include 4 aligned chutes, to provide a transfer device 202 of a total of 8 chutes. Each chute can hold numerous sensors 30 or other components or payloads. For example, each chute can hold twenty sensors 30, allowing the transfer device 202 to hold a total of 160 sensors. These 160 sensors can be accessed by two underwater vehicles simultaneously from opposite sides of the transfer device 202, thereby reducing the off-loading during by 50% relative to having just one underwater vehicle performing the off-loading process at a time.

The transfer device 202 can include one or more skegs 310 to provide directional stabilization for the transfer device 202 as the marine vessel 5 tows the transfer device 202 through the aqueous medium. The skegs 310 can be located at a portion of the transfer device 202 external to the transfer device 202. The transfer device 202 can include one or more skegs 310. For example, the transfer device 202 can include two skegs 310 that are located closer to the second vertical side 214 than the first vertical side 212. The transfer device 202 can include a first skeg 310 located proximate to the fifth chute 302, and a second skeg 310 located proximate to the third chute 230. The skeg 310 can be located at the rear of the transfer device 202, where the rear corresponds to the back end (or second vertical side 214) of the transfer device when the transfer device 202 is moving forward when towed by the marine vessel 5, in which case the first vertical side 212 can be referred to as the front end of the transfer device 202.

The skeg 310 can refer to an extension of or off the transfer device 202 that is configured to keep the transfer device 202 moving straight when towed by the marine vessel 5. The skeg 310 can be formed of, include, or be coated with any material or substance. The skeg 310 can include one or more material or substance similar to the transfer device 202. For example, the skeg 310 can include steel, metal, aluminum, alloys, plastics, rubber, fiberglass, glass, or other materials or substances.

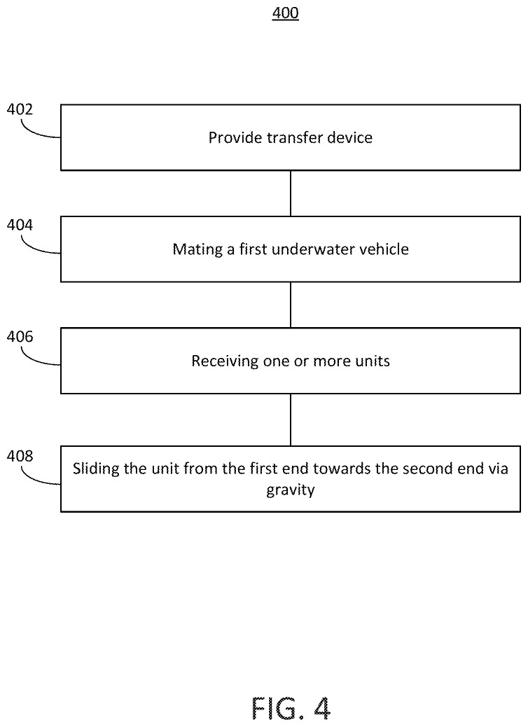

FIG. 4 depicts a flow diagram of a method of performing a seismic survey in an aqueous medium, in accordance with an implementation. The method 400 can be performed by or using one or more system or component depicted in FIG. 1, 2 or 3, including, for example, a transfer device, chutes, sensors, an underwater vehicle, a retainer, or a marine vessel. The method 400 can include providing a transfer device at ACT 402. A marine vessel can lower the transfer device into an aqueous medium, such as an ocean or sea. The marine vessel can lower the transfer device using a crane. The transfer device can be coupled to the crane via a rope and a rope connector on the transfer device. The rope can be unpowered, in that the rope may not be configured to delivery power to the transfer device. In some cases, the transfer device can be coupled to the crane via a cable. The cable may or may not be operational to deliver power to the transfer device. The cable can be configured to provide data communication. The cable may be configured to provide minimal power, such as 5 watts of power, but not sufficient power to power a transfer device with high energy use.

The transfer device can include one or more groups of aligned chutes that configured to allow sensors or other components to slide from a high end of the chute to a low end of the chute via gravity. For example, the transfer device can include eight chutes configured as two groups of four aligned chutes, where the first group of aligned chutes have a reverse slope relative to the second group of aligned chutes.

At ACT 404, the a first underwater vehicle can mate with a chute in the transfer device. The first underwater vehicle can mate with an end of the chute. If the underwater vehicle is onloading sensors to the transfer device, the underwater vehicle can mate with a high end of the chute. If the underwater vehicle is offloading sensors from the transfer device, the underwater vehicle can mate with a low end of the chute.

Mating with an end of the chute can include the underwater vehicle latching to a component mechanism at the end of the chute, and locking the latch. When mated with the transfer device, the underwater vehicle and the transfer device may move as one device such that ocean currents or motions may not detach or disengage the underwater vehicle from the transfer device.

Mating with the transfer device can include a robotic arm of the underwater vehicle opening a gate or other retainer at the end of the chute. The retainer can be a gravity gate, for example, that is unpowered. The transfer device may be unpowered, or not have sufficient energy to control a gate. Thus, the gate can be opened and closed via a robotic arm of the underwater vehicle. The robotic arm can lift the gate or otherwise open the gate. The robotic arm can hold the gate open until offloading or onloading of the units have completed. The robotic arm can release the gate, which can cause the gate to automatically close. The gate can close based on gravity pulling the gate closed. In some cases, the robotic can close the gate. Thus, the robotic arm can actuate the retainer to an open or closed position.

At ACT 406, the underwater vehicle or the transfer device can receive one or more units. Once mated, the underwater vehicle or the transfer device can receive one or more units. For example, if the underwater vehicle is offloading units from the transfer device, then the underwater vehicle can mate with a low end of a chute and receive units from the transfer device. If, however, units are being onloading to the transfer device, then the underwater vehicle can mate with a high end of the chute and the transfer device can receive units from the transfer device.

In an illustrative example, when deploying sensors or other units to perform a seismic survey or other data collection operation, the underwater vehicle can mate with the low end of the chute and receive units. The underwater vehicle can then place the units on a seabed or floor of the aqueous medium. The units can couple with the seabed or floor of the ocean in order to collect data. When returning the units to the transfer device, either upon completion of the survey or other event, the underwater vehicle can retrieve the units from the seabed, mate with a high end of a chute on the transfer device, and then transfer the units to the chute. The transfer device can receive the units from the underwater vehicle via the high end. The units being received can contain collected data stored in a storage device of the unit.

At ACT 408, the units can slide from a first end towards the second end via gravity. The units can slide from a high end towards a low end. During either onloading or offloading of units to the transfer device, the units can slide from the high end towards the low end. For example, when offloading units from the transfer device, the unit can slide from the high end towards the low end as units slide off the chute towards and into the underwater vehicle. When onloading units to the transfer device, the units can slide from the underwater vehicle and into the high end of the chute, and then towards the low end via gravity.

The transfer device can be used to hold or contain any type of unit or payload, such as sensors, instruments, beacons, receivers, transmitters, etc. The units can collect any type of data, including seismic data, perform earthquake & tsunami monitoring, marine mammal or predator detection, bathymetry, electromagnetic, temperature data, pressure data, salinity data, pH data, etc.

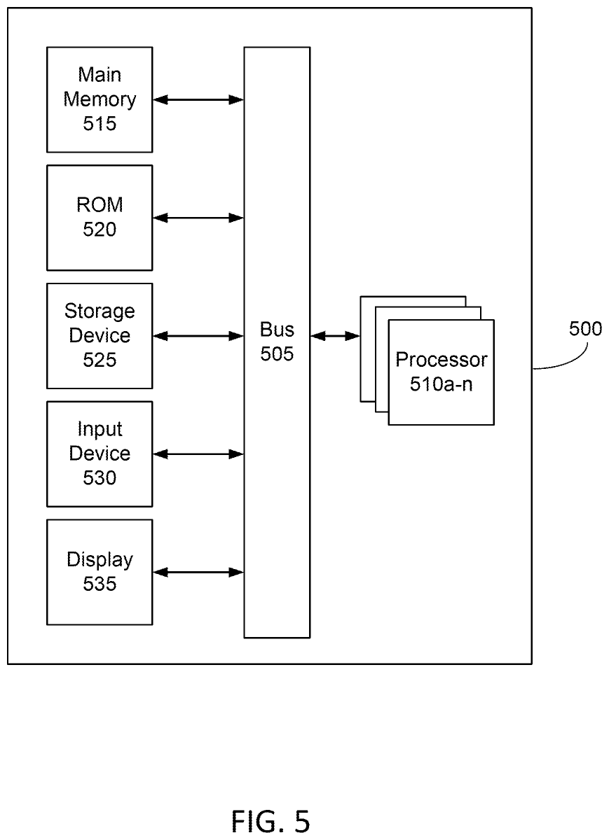

FIG. 5 depicts a block diagram of an architecture for a computing system employed to implement various elements of the systems or components depicted in FIG. 1 or FIG. 2. FIG. 5 is a block diagram of a data processing system including a computer system 500 in accordance with an embodiment. The data processing system, computer system or computing device 500 can be used to implement one or more component configured to filter, translate, transform, generate, analyze, or otherwise process the data or signals depicted in FIGS. 1-9. The computing system 500 includes a bus 505 or other communication component for communicating information and a processor 510 or processing circuit coupled to the bus 405 for processing information. The computing system 500 can also include one or more processors 510 or processing circuits coupled to the bus for processing information. The computing system 500 also includes main memory 515, such as a random access memory (RAM) or other dynamic storage device, coupled to the bus 505 for storing information, and instructions to be executed by the processor 510. Main memory 515 can also be used for storing seismic data, binning function data, images, reports, tuning parameters, executable code, temporary variables, or other intermediate information during execution of instructions by the processor 510. The computing system 500 may further include a read only memory (ROM) 520 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535 or display device, such as a liquid crystal display, or active matrix display, for displaying information to a user. An input device 530, such as a keyboard including alphanumeric and other keys, may be coupled to the bus 505 for communicating information and command selections to the processor 510. The input device 530 can include a touch screen display 535. The input device 530 can also include a cursor control, such as a mouse, a trackball, or cursor direction keys, for communicating direction information and command selections to the processor 510 and for controlling cursor movement on the display 535.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In some embodiments, hard-wired circuitry may be used in place of or in combination with software instructions to effect illustrative implementations. Thus, embodiments are not limited to any specific combination of hardware circuitry and software.

Although an example computing system has been described in FIG. 5, embodiments of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources. The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, microprocessors, and any one or more processors of a digital computer. A processor can receive instructions and data from a read only memory or a random access memory or both. The elements of a computer are a processor for performing actions in accordance with instructions and one or more memory devices for storing instructions and data. A computer can include, or be operatively coupled to receive data from or transfer data to, or both, one or more mass storage devices for storing data, e.g., magnetic, magneto optical disks, or optical disks. A computer need not have such devices. Moreover, a computer can be embedded in another device, e.g., a personal digital assistant (PDA), a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The implementations described herein can be implemented in any of numerous ways including, for example, using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to or receive communications from other devices. The display unit(s) may be provided, for example, to allow a user to view various information in connection with execution of the instructions. The user input device(s) may be provided, for example, to allow the user to make manual adjustments, make selections, enter data or various other information, or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages or programming or scripting tools, and also may be compiled as executable machine language code or intermediate code that is executed on a framework or virtual machine.

In this respect, various concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the solution discussed above. The computer readable medium or media can be transportable, such that the program or programs stored thereon can be loaded onto one or more different computers or other processors to implement various aspects of the present solution as discussed above.

The terms “program” or “software” are used herein to refer to any type of computer code or set of computer-executable instructions that can be employed to program a computer or other processor to implement various aspects of embodiments as discussed above. One or more computer programs that when executed perform methods of the present solution need not reside on a single computer or processor, but may be distributed in a modular fashion amongst a number of different computers or processors to implement various aspects of the present solution.

Computer-executable instructions may be in many forms, such as program modules, executed by one or more computers or other devices. Program modules can include routines, programs, objects, components, data structures, or other components that perform particular tasks or implement particular abstract data types. The functionality of the program modules can be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system to perform a seismic survey in an aqueous medium, comprising:
a transfer device comprising:
a first vertical side and a second vertical side opposite the first vertical side;
a first chute to receive a first plurality of units, the first chute extends from the first vertical side to the second vertical side and traverses a vertical axis of the transfer device, the first chute having a first end at the first vertical side that is higher than a second end at the second vertical side opposite the first end to establish a first slope for the first chute, the first slope of the first chute to cause the first plurality of units to slide from the first end of the first chute towards the second end of the first chute via gravity;
a retainer at the second end of the first chute to be actuated by an arm of a first underwater vehicle that mates with the first chute; and
a rope connector affixed to a portion of the transfer device, the rope connector to couple a first end of a rope to the transfer device, wherein a second end of the rope couples to a component on a marine vessel to tow the transfer device through the aqueous medium.

2. The system of claim 1, wherein the transfer device comprises:
a second chute to receive a second plurality of units, the second chute having a third end at the first vertical side and a fourth end at the second vertical side, wherein the third end is higher than the fourth end.

3. The system of claim 2, wherein the second chute has a second slope that matches the first slope of the first chute.

4. The system of claim 1, wherein the transfer device comprises one or more skegs to provide directional stabilization for the transfer device towed by the marine vessel in the aqueous medium.

5. The system of claim 1, comprising:
the transfer device to receive, at the first end of the first chute, a first seismic data acquisition of the first plurality of units from the first underwater vehicle or a conveyor on the marine vessel.

6. The system of claim 1, comprising:
the transfer device to present, at the second end of the first chute, a first unit of the first plurality of units to the first underwater vehicle for deployment on a seabed.

7. The system of claim 1, wherein the transfer device comprises:
a second chute to receive a second plurality of units, the second chute having a third end at the first vertical side and a fourth end at the second vertical side, wherein the third end is lower than the fourth end.

8. The system of claim 7, wherein the second chute has a second slope that is opposite of the first slope of the first chute.

9. The system of claim 7, comprising the transfer device to:
receive, at the first end of the first chute, at least one of the first plurality of units from the first underwater vehicle; and
receive, at the fourth end of the second chute, at least one of the second plurality of units from a second underwater vehicle.

10. The system of claim 7, wherein receipt of the first plurality of units by the first chute overlaps with receipt of the second plurality of units by the second chute.

11. The system of claim 1, wherein the transfer device is unpowered and the rope lacks a power delivery capability.

12. The system of claim 1, wherein the transfer device comprises:
four first chutes having the first slope; and
four second chutes having a second slope opposite the first slope, wherein each of the four first chutes and each of the four second chutes is configured to hold at least twenty units.

13. The system of claim 1, wherein the first chute comprises a damper configured to dampen a rate at which the first plurality of units slide down the first chute from the first end to the second end.

14. The system of claim 1, wherein the first plurality of units comprise a plurality of seismic units to collect seismic data corresponding to signals reflected or refracted off subsurface features.

15. A method to perform a seismic survey in an aqueous medium, comprising:
providing a transfer device comprising:
a first vertical side and a second vertical side opposite the first vertical side;
a first chute extending from the first vertical side to the second vertical side and traversing a vertical axis of the transfer device, the first chute having a first end at the first vertical side that is higher than a second end at the second vertical side opposite the first end to establish a first slope for the first chute,
a retainer at the second end of the first chute; and
a rope connector affixed to a portion of the transfer device;
mating a first underwater vehicle at the first end of the first chute;
receiving, by the first chute at the first end, a first plurality of units from the first underwater vehicle; and
sliding, by the first plurality of units, from the first end of the first chute towards the second end of the first chute via gravity.

16. The method of claim 15, comprising:
receiving, by a second chute, a second plurality of units, the second chute having a third end at the first vertical side and a fourth end at the second vertical side, wherein the third end is higher than the fourth end.

17. The method of claim 16, wherein the second chute has a second slope that matches the first slope of the first chute.

18. The method of claim 15, comprising:
receiving, by a second chute of the transfer device, a second plurality of units, the second chute having a third end at the first vertical side and a fourth end at the second vertical side, wherein the third end is lower than the fourth end, wherein the second chute has a second slope that is opposite of the first slope of the first chute;
receiving, by the transfer device at the first end of the first chute, at least one of the first plurality of units from the first underwater vehicle; and
receiving, by the transfer device at the fourth end of the second chute, at least one of the second plurality of units from a second underwater vehicle.

19. The method of claim 18, wherein the first underwater vehicle is mated with the first vertical side of the transfer device at a same time as the second underwater vehicle is mated with the second vertical side of the transfer device.

20. The method of claim 15, comprising:
retrieving, by the first underwater vehicle, a first unit of the first plurality of units from the second end of the first chute; and
placing, by the first underwater vehicle, the first unit in contact with a seabed.
